(19) United States
(12) Patent Application Publication
(10) Pub. No.: US 2009/0228874 A1
(43) Pub. Date: Sep. 10, 2009

(54) METHOD AND SYSTEM FOR CODE COMPILATION

(75) Inventors: Andy Lambrechts, Leuven (BE); Praveen Raghavan, Srirangam, Trichy (IN); Murali Jayapala, Leuven (BE); Francky Catthoor, Temse (BE)

Correspondence Address: KNOBBE MARTENS OLSON & BEAR LLP, 2040 MAIN STREET, FOURTEENTH FLOOR, IRVINE, CA, 92614, US

(73) Assignees: Interuniversitair Microelektronica Centrum vzw (IMEC), Leuven (BE); Katholieke Universiteit Leuven, Leuven (BE)

(21) Appl. No.: 12/399,831

(22) Filed: Mar. 6, 2009

Related U.S. Application Data
(60) Provisional application No. 61/034,689, filed on Mar. 7, 2008.

(51) Int. Cl. G06F 9/45

(52) U.S. Cl. 717/146

(57) ABSTRACT

A system and method for converting on a computer environment a first code into a second code to improve performance or lower energy consumption on a targeted programmable platform is disclosed. The codes represent an application. In one aspect, the method includes loading on the computer environment the first code and for at least part of the variables within the code the bit width required to have the precision and overflow behavior as demanded by the application. The method further includes converting the first code into the second code by grouping operations of the same type on the variables for joint execution on a functional unit of the targeted programmable platform, the grouping operations using the required bit width, wherein the functional unit supports one or more bit widths, the grouping operation being selected to use at least partially one of the supported bit widths.

### CROSS REFERENCE TO RELATED APPLICATIONS

This application claims priority under 35 U.S.C. §119(e) to U.S. provisional patent application 61/034,689 filed on Mar. 7, 2008, which application is herein incorporated by reference in its entirety.

### BACKGROUND OF THE INVENTION

In the field of synthesis code conversion methods exist which enable synthesis of a more efficient ASIC, whereby the methods are explicitly exploiting detailed word lengths and not the typically approximations like powers of 2. However such methods do not exist in the field of compilation of code for programmable platforms nor it is a priori likely that such use in this field might give any advantage since the increase in complexity seems to be without benefit since programmable platforms (with fixed predesigned functional units) do not offer much flexibility to exploit such information.

During the fixed point refinement step of a design, the application knowledge of the designer and end requirements of the platform (e.g. Bit Error Rate) can be exploited to obtain a range of word-widths, each valid in a certain scenario. For DSP implementations the minimal word-width, e.g. required to prevent overflows, is traditionally round to the widths supported by the processor (e.g. 8, 16 and 32 bit) although this width can even depend on specific use-cases or system scenarios (e.g. quality of wireless connection, or best possible audio quality, depending on current state of the battery of a wireless device).

Currently the design process targeting programmable processors rounds the number of required bits to short, int, long and SIMD capable hardware only supports 8, 16, 32 bits, or wider powers of 2 in some cases. When performing fixed point refinement for ASICs, bit width analysis does not have these restrictions and the cheapest bit width that can provide the required overflow behavior and precision can be used.

For programmable platforms designers round to the next bigger available width, and try to group the widths that are used, because processors only support SIMD modes in which all subword sizes are of equal width (e.g. 4×8, 2×16 or 32). This leads to wasted bits, both in computation and in storage.

Emulating SIMD on processors that do not support this in hardware, also calling this Software SIMD or Soft SIMD but they restrict word-widths still to 8, 16 or 32 bits. Because of this restriction however, they do not require the representation of very heterogeneous word-widths in the compiler and passing on this information from the fixed point refinement to the rest of the compilation flow, which simplifies the work.

Tarun Nakra et all (“Width-Sensitive Scheduling for Resource-Constrained VLIW Processors” ACM workshop on feedback directed and dynamic optimization) discussed width info based on profiling, with detection of error and recovery for embedded VLIW processor but still 8, 16 and 32 bit and hardware support to break carry chain focus on performance improvement on resource contrained VLIW processors, using profiling information. They modify the fetch logic and the FU to load more registers in parallel to prevent explicit pack, or add extra issue logic to fetch parallel ops in unused slot and redistribute the operands after register read to the correct FU. They however allow heterogeneous operations (e.g add and compare) to be scheduled together on same ALU for different sub words of same length and powers of 2, which gives a performance boost, since it allows a Multiple Instruction Multiple Data approach.

### SUMMARY OF CERTAIN INVENTIVE ASPECTS

Certain inventive aspects relate to compile or pre-compile methods for converting first code into second code, such that the second code has an improved execution on a targeted programmable platform, whereby the methods are explicitly exploiting for at least part of the data in the codes the detailed word length and not the typically approximations like powers of 2.

Such methods have steps of grouping operations on data for joint execution on a functional unit of the targeted platform, steps of scheduling operations on data in time and steps of assigning operations to an appropriate functional unit of such platform. The detailed word-length information is used in at least one of the steps of grouping, scheduling or assigning.

The method creates benefits also in programmable platforms when careful application of such detailed word-length information is done by identifying interesting parts within the first code for performing the steps of grouping, scheduling and/or assigning.

As an example wherein the detailed word length information is used is the use of software SIMD (single instruction multiple data) instructions (instead of hardware SIMD), which is a concept whereby guard data—like zero's is added to the data, such that joint operation on the data is not jeopardizing the correctness of the operation. In particular in the context of the invented compile method the use of the software SIMD concept on heterogeneous word-length, meaning that the SIMD concept is used on data wherein the actual word-length is varying (due to the nature of the instructions operating on the data) over the code.

The careful selection as described before comprises in such an example of inspection for data of different dynamic range as indicator for determining interesting code portions in the first code.

As an example wherein the detailed word length information is used a method is disclosed for re-arranging code such that data can remain as long as possible in a compacted format, meaning the multiple operations can be executed on it in such format.

As another example of careful application of conversion steps is the use of a preparation step, wherein selectively multiplications are converted into add and shift operations. Note that such conversion will typically lead to an increase of accesses to the instruction memory hierarchy, hence increase in energy consumption. However the combination of such conversion step with the software SIMD, in particular for heterogeneous word lengths, may lead to a decrease, if properly applied. The compiler will hence evaluate the amount of accesses and the amount of energy consumed per access.

Certain inventive aspects will give more benefits when applied to long word lengths. Combination with compilation techniques leading to such long word lengths (as disclosed in EP 05447054) is recommended.

Further the use within such predetermined architectures of a dedicated shift-shift-add block is recommended to maximally exploit the multiplication conversion step.

As a conclusion use of subwords of different length in a SIMD approach, in particular a soft SIMD approach is disclosed. These lengths can be non powers of two.

Still another aspect relates to a method of converting on a computer environment a first code into a second code, the codes representing an application, such that the second code has an improved performance and/or lower energy consumption on a targeted programmable platform. The method comprises loading on the computer environment the first code and for at least part of the variables within the code the bit width required to have the precision and overflow behavior as demanded by the application. The method further comprises converting the first code into the second code by grouping operations of the same type on the variables for joint execution on a functional unit of the targeted programmable platform, the grouping operations using the required bit width, wherein the functional unit supports one or more bit widths, the grouping operation being selected to use at least partially one of the supported bit widths.

Still another aspect relates to a computer-readable medium having stored therein a program which, when executed, performs the method described above.

Still another aspect relates to a system for converting on a computer environment a first code into a second code, the codes representing an application, such that the second code has an improved performance and/or lower energy consumption on a targeted programmable platform. The system comprises a loading module for loading on the computer environment the first code and for at least part of the variables within the code the bit width required to have the precision and overflow behavior as demanded by the application. The system further comprises a converting module for converting the first code into the second code by grouping operations of the same type on the variables for joint execution on a functional unit of the targeted programmable platform, the grouping operations using the required bit width, wherein the functional unit supports one or more bit widths, the grouping operation being selected to use at least partially one of the supported bit widths.

Still another aspect relates to a system for converting on a computer environment a first code into a second code, the codes representing an application, such that the second code has an improved performance and/or lower energy consumption on a targeted programmable platform. The system comprises means for loading on the computer environment the first code and for at least part of the variables within the code the bit width required to have the precision and overflow behavior as demanded by the application. The system further comprises means for converting the first code into the second code by grouping operations of the same type on the variables for joint execution on a functional unit of the targeted programmable platform, the grouping operations using the required bit width, wherein the functional unit supports one or more bit widths, the grouping operation being selected to use at least partially one of the supported bit widths.

### DETAILED DESCRIPTION OF CERTAIN INVENTIVE EMBODIMENTS

Certain embodiments relate to compile methods, compilers implementing the methods, storage media with the instructions for carrying out the methods, ways of execution of code as compiled with the methods or by the compiler on a programmable architectures, platforms and processors components and arrangements within the programmable architectures, platforms or processors for enhancing such execution and for having greater benefits of the proposed methods, simulators for such programmable architectures, platforms or processors for evaluating the effect of the methods on the eventual execution.

Certain embodiments relate to methods of and/or a compiler for changing, modifying code such that improved execution in terms of power consumption and performance on a programmable architectures, platforms and processors is achieved, in particular focusing on the carrying out of instructions within the code on a functional unit of the architecture, in particular the data path. However the method may also evaluate the effect on the foreground memory wherein data is stored and on the instruction memory. Moreover the method may separately or joined operate on instructions on data of the application described by the code and instructions on variables introduced for addressing application data.

One key feature of certain embodiments is the exploiting of word-width information.

Certain inventive embodiments disclose use of detailed energy models used in energy estimation wherein the impact of the data on the toggling of a component is modeled are explicitly or by approximation. Further processor and platform simulators extended to make use of this these more detailed energy models are presented.

Further the exploitation of word-width information is performed with case by using a selective approach whereby by use of such processor and/or platform simulators either for a particular code it can be decided to use or not to use the method based on expected gains and if decided to use the method, to select these portions of the code wherein such method should be applied.

The more detailed word-width information based models are further used for steering the transformations and optimizations.

When the result of fixed point refinement is not rounded to traditionally available word sizes, a more heterogeneous range of widths is available. This leads to opportunities in packing different word sizes together, in order to manipulate them together: perform computations and load/store them to memory. This could be used to combine operations to increase parallelism, or to reduce the memory footprint.

Different operations have to be handled in different ways, depending on the type of operation, on the number representation and on the potential hardware support of the machine. If needed pack and unpack operations have to be inserted (depends on the data layout), masking has to be performed and sign bits have to be (re-)set. Unlike some other preprocessing optimizations, we may expect that this technique will be only useful for a restricted set of applications, ranges of data operands and even operations or number representations. If the overhead can be limited, e.g. by going to different number representations, and the number of extra operations for pack/unpack and masking can be limited, it could however give significant gains in both energy and performance. If the register file base cost (the part of the access cost that is independent of the accessed width) is made small enough the gains will be significant. This will in particular be the case for custom designed register files, instead of the standard cell ones we have now, and this will be done anyway for power consumption reasons.

Exploiting application knowledge during mapping can lead to big gains, from the algorithmic level down to the implementation. The usage of word-width information (application knowledge) to evaluate different mapping options in terms of energy consumption and performance and the impact on the foreground memory is now disclosed. Certain embodiments may or may not the effect of the methods in the complete memory sub-system.

First it is described how to obtain the word-width information, how to get energy models, how to exploit this information in order to construct more efficient mappings and how to represent this information in the compiler.

The application data word-width information can be obtained in three different ways, namely being the result of an analytical refinement of the algorithm (e.g. value propagation techniques), using profiling (simulation based approach) or using a hybrid

Word-width aware energy modeling is used to steer and guide the code transformations. These word-width aware transformations can exploit word-width information during mapping in order to get more efficient mappings. In order to automate this in a compiler, the word-width information has to be represented and exposed to the compiler.

The word-width aware work can be split in different parts: firstly, obtaining the word-width information, secondly the energy modeling, thirdly, word-width aware optimizations that exploit the word-width information. Additionally, there is a more technical aspect to using word-width in practice, namely representing word-width in a compiler.

In order to be able to exploit variations in word-width in current embedded applications and to reach meaning full gains, two prerequisites have to be met. Firstly, this variation has to be present in the target code. Secondly, the current transformation techniques that can be re-used for the energy and performance improvement, should be made capable of exploiting such variations.

Current state-of-the art techniques can extract this information from applications and make it available to a compiler or designer willing to exploit it.

To validate potential gains of exploiting word-width prior art current energy estimation must be extended to make word-width variations visible. Later this will enable designers for instance by using a suitable simulator to see the potential gains of using this extra info during mapping and enable them to achieve better energy efficiency and higher performance. Simulation and estimation techniques are extended to give more detailed energy estimates.

Word-width knowledge can be used in different ways within the scope of mapping, e.g. during scheduling, during assignment or to enable or guide optimization. In the description we will conceptually detail these options which can be used separately or in a combined form, discuss the state of the art and opportunities and issues for all of them.

To be able to exploit Word-Width information automatically, it has to be represented and visible to the compiler. This can be done in various ways for instance by (manually or automatically inserted) special information sections in the code like pragmas or by new types.

Because of a natural split between both types of operations, splitting address calculation and operations on application data is also possible.

During the fixed point refinement step of the design, the application knowledge of the designer and end requirements of the platform (e.g. Bit Error Rate) can be exploited to obtain a range of word-widths, each valid in a certain scenario. Instead of rounding word widths instead in order not to remove freedom during this ‘cast’, we will keep the minimal bit-width and use it in later optimization or compiler steps.

Although the invented compilation method also targets execution on programmable processors with SIMD capable hardware only supporting 8, 16, 32 bits, or wider powers of 2 or processors only supporting SIMD modes in which all subword sizes are of equal width (e.g. 4×8, 2×16 or 32), information is provided to the compiler on the real word widths, so not a preprocessing step of rounding these word widths is performed.

By keeping the minimal word-width information, more efficient mappings can potentially be reached during subsequent stages of the design.

Future systems could support different usage modes, e.g. to trade off quality of images and sound vs. the energy spent on processing and storage, which could lead to a similar variation. When different types of data are processed together, e.g. audio and video, or even data and coefficient for filtering, heterogeneity in widths is naturally present. This leads to a diversity in widths that potentially could be exploited.

The invented method hence allows for execution of application code in different flavors dependent on the usage mode and type of input data, by selecting a mapped version of the code, based on another word width context.

The expected target domain includes wireless algorithms from the digital front-end (DFE) and the outer part of the inner modem (part of the baseband processing). Additionally it will be applicable to biomedical and some graphics applications.

Current energy models used in energy estimation assume that hardware components (e.g. adders, multipliers) are always operating on data that fill the complete width of these components. When the data used in a certain algorithm are less wide, these components internally toggle less, which leads to a smaller energy consumption. Current processor and platform simulators can easily be extended to make use of this these more detailed energy models, once they are available. In certain embodiments word-width aware models are discussed and how they can be generated. Using an example, we show how the improved accuracy of the energy estimation can influence a designer's decision or prevent wrong conclusions. Given the effort required to generate these width-aware models for every component, and the relative contribution of the energy cost of the data path to the complete system, the need for width-aware modeling must be evaluated case by case. Part of this work has been published in Annex 1.

To steer the transformations and optimizations, precise energy models might not be needed but other indirect indicators can be of use (e.g. use accesses and activations)

To make validation of potential gains when using word-width information possible, first of all word-width aware energy models are needed for every component of the processor.

For processors with a small energy consumption of the data path, it may be sufficient to track activations. Further for some data path components a model based on a linear scaling+offset may be good enough approximation.

Now it is explained how word-width knowledge can be used in different ways within the scope of mapping.

When the result of fixed point refinement is not rounded to traditionally available word sizes, a more heterogeneous range of widths is available. This leads to opportunities in packing different word sizes together, in order to manipulate them together: perform computations and load/store them to memory. This could be used to combine operations to increase parallelism, or to reduce the memory footprint.

Different operations have to be handled in different ways, depending on the type of operation, on the number representation and on the potential hardware support of the machine. If needed pack and unpack operations have to be inserted (depends on the data layout), masking has to be performed and sign bits have to be (re-)set. Unlike some other preprocessing optimizations, we may expect that this technique will be only useful for a restricted set of applications, ranges of data operands and even operations or number representations. If the overhead can be limited, e.g. by going to different number representations, and the number of extra operations for pack/unpack and masking can be limited, it could however give significant gains in both energy and performance. If the register file base cost (the part of the access cost that is independent of the accessed width) is made small enough the gains will be significant. This will in particular be the case for custom designed register files, instead of the standard cell ones we have now, and this will be done anyway for power consumption reasons.

Contrary to the state of the art Software SIMD or SoftSIMD, in certain embodiments no a priori restriction on word-widths to 8, 16 or 32 bits is used. Moreover the flexibility offered by the invented methods allows for operating together on (variable) data and (fixed) coefficients in the code or reducing memory footprint by storing them together be it that a representation of very heterogeneous word-widths in the compiler and passing on this information from the fixed point refinement to the rest of the compilation flow is needed. Here, we will focus on exploiting this extra knowledge, in order to get bigger gains and use the larger freedom to improve mappings where the state of the art methods can not, in particular by (a) handling combinations that can not be or are not handled by HW SIMD (or SoA SoftSIMD) (e.g. 18+4), (b) even when HW SIMD is used, more parallel SW SIMD is made possible, in particular the mixed approach is recommendable. The invented method may introduce preprocessing steps further enabling the method by for instance providing extra pack/unpack instructions.

It is an important aspect of the invention that the width info (which may be obtained by various methods as discussed before) is used for improving not only performance but also energy. Moreover the scale of detail goes lower than the traditional power of 2 approximations and as such is more closely linked with the fixed point refinement. While most prior-art techniques are restricted to a context wherein they only mimic traditional SIMD to do parallel operation on the same type of data, all of the same word-widths: 4×8 and 2×16, the embodiment is aiming at much more heterogeneous widths, which will lead to more opportunities, but also more issues with packing and shuffle/shift.

When the word-width for different signals in the application is known, and many of them are less than the full width of the component, the overall toggling inside components could still be close to the worst case if different widths are mapped to the same unit in an un-grouped fashion. Toggling is only reduced when a unit is operating on many words of the same (small) width consecutively, without wide operations in between.

Hence if dependencies allow, operations should be reordered in time to group equal word-width and minimize toggling. Further group signals of same width on same unit (see assignment) and make sure they are consecutive in time.

Note that for certain extremely energy efficient systems, with heavily optimized data and instruction memories or with very wide datapaths, the impact of the method will be larger.

During the assignment phase, operations are assigned to Functional Units. Word-width information can be potentially used during this step if multiple units can perform the same operations.

When assigning operations to units, word-width aware assignment could improve the energy efficiency in two ways: firstly, to minimize toggling by not mapping signals of different word-width to a unit which is operating on a certain width (same as previous section) and secondly of the mapping if multiple units which are implemented differently can perform the respective operation.

In order to exploit word-width knowledge to improve the efficiency of mappings, we can take three different approaches, namely write assembly, use intrinsics, or make the compiler do the optimizations (in the third case, rewriting of the C code could be needed, in order to present e.g. parallellism in a way such that it can be detected by the compiler). These options are ordered from less to more effort/complex.

When the compiler should evaluate certain trade-offs and perform the optimizations automatically, the word-width information should be represented in the Intermediate Representation (IR).

Since it is common knowledge that address and data computations have different characteristics, like dynamic range and toggle behavior, people have suggested to split these operations onto separate resources. Address Generation Units (AGUs) can be found in some state of the art processors. These units can be customized to the nature of address computations, while the other FUs can be optimized for data computations. This is typically a good idea for data parallel units, since address computations would otherwise disturb the good filling of the SIMD datapath.

Further detail is described in the attached Appendix A, B, and C:
Appendix A: “Enabling Word-Width Aware Energy and Performance Optimizations for Embedded Processors”
Appendix B: “Cost-aware Strength Reduction for Constant Multiplication in VLIW Processors”
Appendix C: “Exploiting word-width information during application mapping”

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention.

What is claimed is:

1. A method of converting on a computer environment a first code into a second code, the codes representing an application, such that the second code has an improved performance and/or lower energy consumption on a targeted programmable platform, the method comprising:
loading on the computer environment the first code and for at least part of the variables within the code the bit width required to have the precision and overflow behavior as demanded by the application; and
converting the first code into the second code by grouping operations of the same type on the variables for joint execution on a functional unit of the targeted programmable platform, the grouping operations using the required bit width, wherein the functional unit supports one or more bit widths, the grouping operation being selected to use at least partially one of the supported bit widths.

2. The method of claim 1, wherein the converting further comprises scheduling the execution in time on the targeted programmable platform of operations on the variables in time, wherein the scheduling of the execution uses the required bit width.

3. The method of claim 1, wherein the converting further comprises assigning of operations to an appropriate functional unit of the targeted programmable platform using the required bit width.

4. The method of claim 1, wherein the functional unit supports one or more bit widths, the grouping operation being selected to use completely one of the supported bit widths.

5. The method of claim 1, wherein the loaded required bit width is obtained by performing a fixed point refinement.

6. The method of claim 1, wherein the computer environment is adapted for representing the required bit width of at least part of the variables (e.g. by providing an extra label indicating the bit width), at least two of the variables having a different bit width.

7. The method of claim 1, wherein, prior to the converting of the first code into the second code, performing analysis to identify code portions within the first code on which the converting to be applied, the analysis using the required bit width.

8. The method of claim 7, wherein the analysis inspects the code for code portions with variables having different bit widths.

9. The method of claim 7, wherein the functional unit supports one or more bit widths, the grouping operation being selected to use completely one of the supported bit widths, and wherein the analysis inspects the code for code portions with variables having a bit width different from the supported bit widths.

10. The method of claim 1, wherein the converting of the first code into the second code comprises introducing based on the required bit width guard data for at least two variables having a different bit width.

11. The method of claim 1, wherein, prior to the converting of the first code into the second code, changing the required bit width for at least one variable if this results in an improved performance and/or lower energy consumption of execution of the second code on the targeted programmable platform.

12. The method of claim 1, wherein the converting of the first code into the second code comprises changing by repacking the assigned bit width or format of a variable before an operation is executed.

13. The method of claim 1, wherein the converting of the first code into the second code is based on the required bit widths and further comprises scheduling the operations such that operations on variables with a same width are grouping in time.

14. The method of claim 1, wherein the method further comprises, prior to the grouping operations, scheduling and assigning at least one multiplication operation such that it is converted into a least one of add and/or shift operations or combinations thereof.

15. The method of claim 1, wherein the converting of the first code into the second code is steered by evaluating the energy consumed per operation by the targeted programmable platform, the evaluation using energy models, inputting the required bit width.

16. The method of claim 1, wherein the supported bit width are powers of 2, while the required bit width is not a power of 2.

17. The method of claim 1, the method further comprising outputting the second code.

18. A computer-readable medium having stored therein a program which, when executed, performs the method of claim 1.

19. A system for converting on a computer environment a first code into a second code, the codes representing an application, such that the second code has an improved performance and/or lower energy consumption on a targeted programmable platform, the system comprising:
a loading module for loading on the computer environment the first code and for at least part of the variables within the code the bit width required to have the precision and overflow behavior as demanded by the application; and
a converting module for converting the first code into the second code by grouping operations of the same type on the variables for joint execution on a functional unit of the targeted programmable platform, the grouping operations using the required bit width, wherein the functional unit supports one or more bit widths, the grouping operation being selected to use at least partially one of the supported bit widths.

20. A system for converting on a computer environment a first code into a second code, the codes representing an application, such that the second code has an improved performance and/or lower energy consumption on a targeted programmable platform, the system comprising:
means for loading on the computer environment the first code and for at least part of the variables within the code the bit width required to have the precision and overflow behavior as demanded by the application; and
means for converting the first code into the second code by grouping operations of the same type on the variables for joint execution on a functional unit of the targeted programmable platform, the grouping operations using the required bit width, wherein the functional unit supports one or more bit widths, the grouping operation being selected to use at least partially one of the supported bit widths.
